(19) United States
(12) Patent Application Publication
(10) Pub. No.: US 2002/0185963 A1
(43) Pub. Date: Dec. 12, 2002

(54) Spacer arrangement for flat panel display

(75) Inventors: Jimmy J. Browning, Boise, ID (US); David H. Wells, Boise, ID (US); Jianping Yang, Austin, TX (US)

Correspondence Address: Robert J. Stern, 3074 Harcross Rd., Woodside, CA, 94062-2321, US

(73) Assignee: Pixtech S.A

(21) Appl. No.: 09/877,322

(22) Filed: Jun. 7, 2001

(51) Int. Cl. H01J 1/62; H01J 63/04

(52) U.S. Cl. 313/495; 313/485; 313/487; 445/24

(57) ABSTRACT

An arrangement of spacer posts in a flat panel display. The spacer posts maintain a fixed separation between a back plate and a face plate. The back plate includes one or more electron emission sources. Phosphors or other electro-optic material are distributed among a plurality of pixel areas on the face plate. The pixel areas are arranged in distinct groups, where each group contains N adjacent pixel areas. Each pixel area includes an area free of phosphor material. Within each group of N pixel areas, the respective phosphor-free areas of the N pixel areas are contiguous so as to form a combined phosphor-free area equal to or greater than the transverse cross-section of one end of a spacer. Consequently, a spacer can be attached to the face plate at each combined phosphor-free area without disrupting the uniformity of the distribution of phosphors on the face plate.

### GOVERNMENT INTEREST

This invention was made with Government support under contract number DABT63-97-C0001 awarded by the Defense Advanced Research Projects Agency (DARPA). The Government has certain rights in this invention.

### FIELD OF THE INVENTION

The invention relates generally to the mechanical structure of flat panel displays having two parallel plates separated by spacer posts. More specifically, the invention relates to the arrangement of such spacer posts among the electron emitters or phosphors on one of the plates of the display.

### BACKGROUND OF THE INVENTION

Many types of flat panel displays are constructed using two parallel plates: a back plate (also called a cathode plate or substrate) and a face plate (also called an anode plate). An array of light-emitting phosphors and at least one anode electrode are formed on the face plate, and at least one electron source is formed on the back plate.

A side wall encircles and sealingly attaches to the back plate and face plate so as to form a sealed cavity between the two plates. During manufacture of the display a vacuum is established in the cavity so that electrons traveling from the back plate to the face plate do not collide with gas molecules.

The phosphors are divided among thousands or millions of pixels, where a pixel is defined as the smallest area of the display that can be independently addressed, i.e., the smallest area whose light output or current flow can be controlled independently of the other pixels. In a color display, the phosphors of each pixel are further divided into three or four different colors of phosphor, where the phosphors (and, in some displays, the corresponding electron source) for a single color within a pixel are referred to as a sub-pixel.

The separation between the two parallel plates is maintained by dielectric spacer posts. The spacer posts must prevent the two plates from distorting due to the pressure differential between the vacuum in the cavity between the plates and the atmospheric pressure on the outer surfaces of the two plates. Very small displays can rely entirely on spacers around the perimeter of the plates. However, to prevent the two plates from bending inward, displays larger than a few centimeters in width generally require an array of spacer posts distributed across the surface of the two plates, including the area occupied by the phosphors and the electron source.

Commonly assigned U.S. Pat. No. 6,004,179 issued Dec. 21, 1999 to Alwan shows a flat panel field emission display having a spacer post for every pixel. However, for typical field emission displays having a lateral spacing or pitch between pixels of only 0.2 mm or less, one spacer post for every pixel is excessive; one spacer post for every 25 to 100 pixels should suffice. Reducing the number of spacer posts by a factor of 25 or 100 would substantially reduce the cost of manufacturing a display.

When not every pixel includes a spacer post, it would be desirable to arrange the spacer posts so that a person viewing the display cannot perceive a difference between the pixels having an adjacent spacer post and the pixels not having an adjacent spacer post. Specifically, it would be desirable to position the spacer posts so that the posts do not interfere with the pixel-to-pixel uniformity of both the phosphor size and the lateral spacing between the phosphors.

It also would be desirable to attach the spacer posts to the back plate and face plate in such a way as to tolerate some misalignment of the spacer posts without damaging the operation of the display. Tolerating such misalignment should contribute to reducing the cost of manufacturing displays and increasing the production yield.

### SUMMARY OF THE INVENTION

The invention relates to the arrangement of spacer posts in a flat panel display. Specifically, the invention is a flat panel display comprising at least one electron source mounted on a back plate (or substrate) and comprising phosphors or other electro-optic material distributed among a plurality of pixel areas on a face plate. A plurality of spacer posts maintains a fixed separation between the back plate and the face plate.

A first aspect of the invention relates to the attachment of spacer posts to the face plate of the display. Specifically, each pixel area on the face plate includes an area free of phosphor material. The pixel areas on the face plate are arranged in distinct groups, where each group contains N adjacent pixel areas. (N=2 in the preferred embodiment, but N can be any number.) Within each group of N pixel areas, the respective phosphor-free areas of the N pixel areas are contiguous so as to form a combined phosphor-free area equal to or greater than the transverse cross-section of one end of a spacer. Consequently, a spacer can be attached to the face plate at each combined phosphor-free area without disrupting the uniformity of the distribution of phosphors on the face plate.

Because the number of pixels exceeds the number of spacer posts required to mechanically support the display, the number of spacer posts is no more than one-half the number of combined phosphor-free areas in the display, so that no more than one-half of the combined phosphor-free areas are attached to any of the spacer posts.

A second aspect of the invention relates to the attachment of spacer posts to the back plate (or substrate) of a field emission display. Specifically, the invention is a field emission display comprising a plurality of field emitter tips distributed among a plurality of pixel areas on a back plate, and comprising a phosphor material mounted on a face plate. A plurality of spacers establish a fixed separation between the back plate and a face plate. In the invention, the pixel areas on the back plate are arranged in distinct groups, where each group contains N pixel areas. (N=2 in the preferred embodiment, but N can be any number.)

Each pixel area on the back plate includes an area free of field emitter tips, wherein the emitter-free area of each pixel is equal to or greater than the transverse cross-section of one end of a spacer divided by N. Within a group, the respective emitter-free areas of the N pixel areas are contiguous so as to form a combined emitter-free area equal to or greater than the transverse cross-section of one end of a spacer. Consequently, a spacer can be attached to the back plate at each combined emitter-free area without disrupting the uniformity of the distribution of field emitter tips on the back plate.

Because the number of pixels exceeds the number of spacer posts required to mechanically support the display, the number of spacer posts is no more than one-half the number of combined emitter free areas in the display, so that no more than one-half of the combined emitter-free areas are attached to any of the spacer posts.

A third aspect of the invention is a flat panel display in which each phosphor-free area to which a spacer post is attached has a substantially greater surface area than the abutting end of the spacer post, so that the spacer post can be substantially misaligned without extending outside the phosphor-free area. A preferred means for providing such a large phosphor-free area is to correspondingly reduce the area occupied by the phosphor of one color, i.e., reduce the area occupied by one sub-pixel within each pixel. The color phosphor whose area is less than that of the other color phosphors preferably is selected as the color phosphor requiring the least electrical current to produce the desired light emission.

### BRIEF DESCRIPTION OF THE DRAWINGS

FIG. 1 is a cut-away perspective view of a portion of a display according to the invention.

FIG. 2 is a plan view of a portion of the face plate.

FIG. 3 is a plan view of a portion of the back plate showing an array of gate electrodes and spacer posts.

FIG. 4 is a detailed plan view of the gate electrodes of two pixels in which the combined emitter-area is vacant.

FIG. 5 is a detailed plan view of the gate electrodes of two pixels in which the combined emitter-area is occupied by a spacer post.

FIG. 6 is a sectional view of the face plate and back plate of one pixel.

FIG. 7 is a detailed, perspective, sectional view of the back plate of one sub-pixel.

FIG. 8 is a plan view of the field emitter tips of one sub-pixel.

FIG. 9 is plan view (like FIG. 2) of a portion of the face plate in an alternative embodiment wherein N=1.

FIG. 10 is plan view (like FIG. 2) of a portion of the face plate in an alternative embodiment wherein N=4.

### DETAILED DESCRIPTION OF THE PREFERRED EMBODIMENTS

Conventional Aspects of Display

The conventional components of our preferred embodiment will be discussed before describing the novel features.

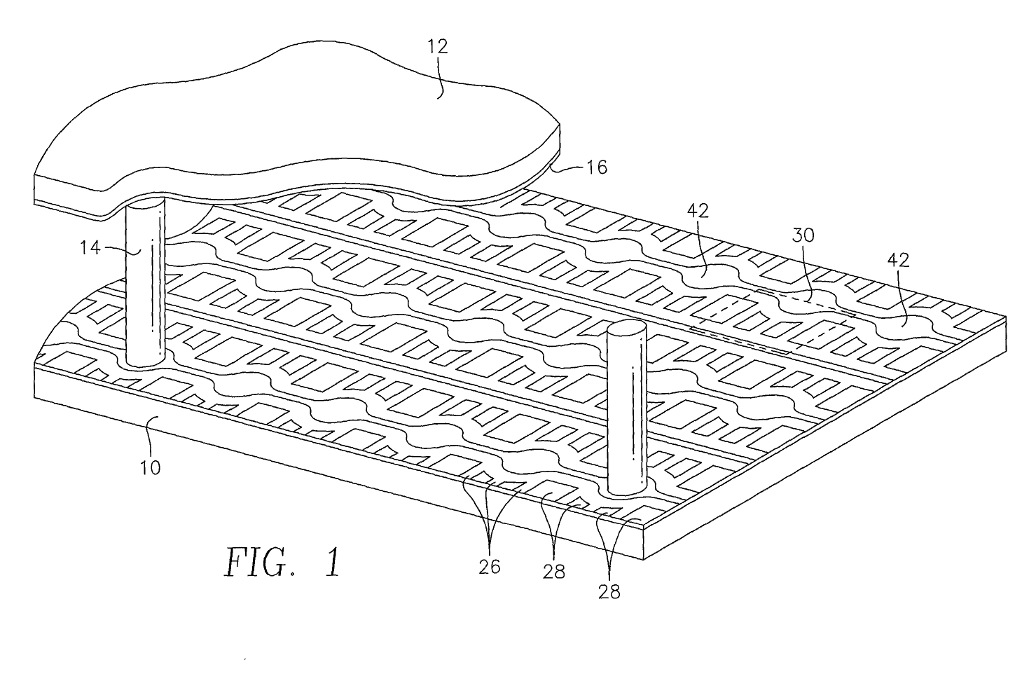

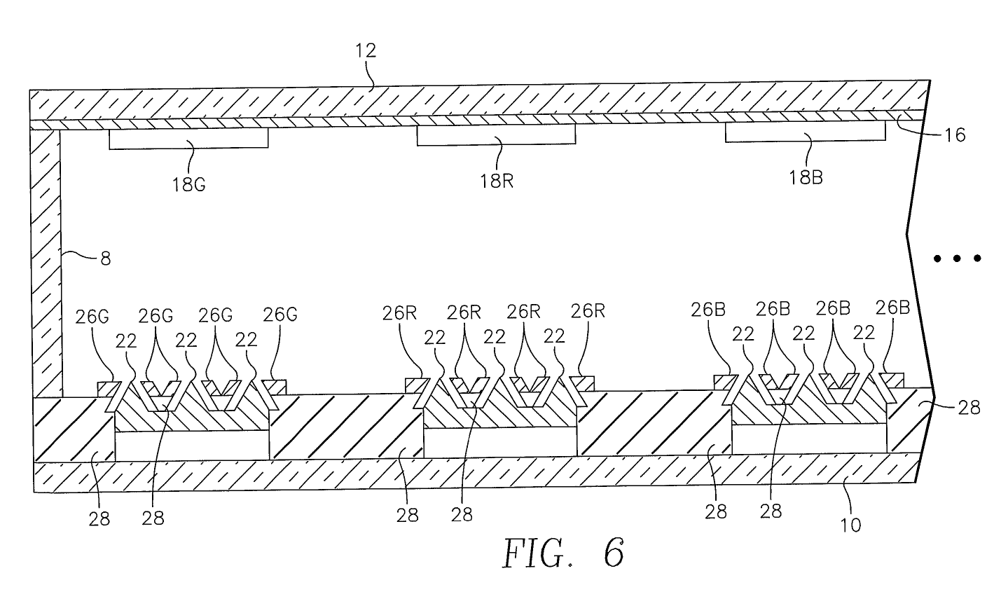

The display has a vacuum-filled cavity enclosed by a back plate or substrate 10, a face plate or anode plate 12, and a perimeter wall 8 (FIGS. 1 and 6). The perimeter wall 8 encircles and sealingly attaches to the back plate 10 and face plate 12 so as to form a sealed cavity between the two parallel plates. During manufacture of the display a vacuum is established in the cavity. The purpose of the vacuum is to permit electrons to travel from the back plate to the face plate without colliding with gas molecules.

The pressure differential between the atmospheric pressure on the outer surfaces of the two plates 10, 12 and the vacuum in the cavity between the plates tends to bend the plates inward, thereby distorting the flatness of the plates. To prevent such distortion, displays larger than a few centimeters in width typically employ an array of dielectric spacer posts 14 distributed across the surfaces of the two plates (FIGS. 1, 3 and 5). The spacer posts are attached to and extend between the two plates so as to maintain the two plates parallel to each other and with a fixed separation between the plates.

At least one electron source (the cathode) is formed on the front surface of the back plate 10 i.e., the surface of the back plate that faces the face plate. At least one anode electrode 16 and an array of pixels of light-emitting phosphors 18 are formed on the rear surface of the face plate 12 i.e., the surface of the face plate that faces the back plate (FIG. 6).

In a typical color display, there are red phosphors 18R, green phosphors 18G, and blue phosphors 18B. Some color displays have four colors of phosphors. A monochrome or gray scale display has only phosphors of one color.

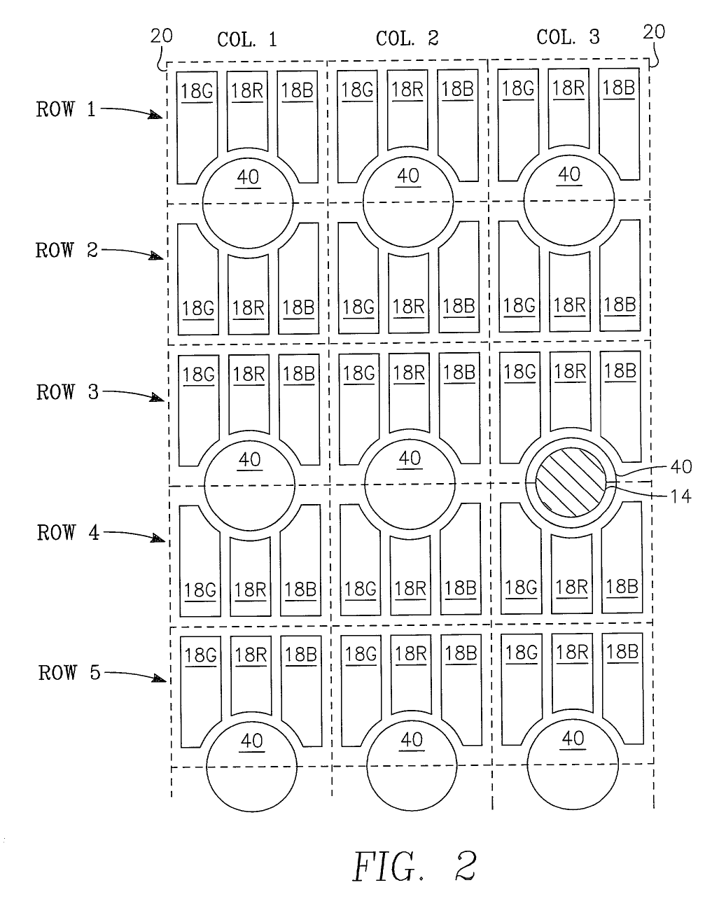

The rear surface of the face plate 12 is functionally divided into thousands or millions of pixel areas 20 (FIG. 2). The pixel areas of the face plate are arranged in a rectangular matrix of rows and columns, so that if the display has M rows and N columns, then the number of pixels in the display is M×N. Each pixel can be uniquely identified by the row and column to which it belongs. (In FIG. 2, the dashed lines represent the boundaries between adjacent pixel areas. The dashed horizontal and vertical lines represent the boundaries between adjacent rows and columns, respectively.)

Each pixel of phosphor material 18 is mounted on a distinct, corresponding pixel area 20 of the face plate (FIG. 2). In a color display, each pixel of phosphor material comprises a plurality (typically three or four) of sub-pixels of different colors of phosphor material. Typically, the three sub-pixels within each pixel of phosphor material consist of a red sub-pixel 18R of phosphor material that emits red light, a green sub-pixel 18G of phosphor material that emits green light, and a blue sub-pixel 18B of phosphor material that emits blue light.

The sub-pixel is the smallest region of phosphor material whose light output or current flow can be controlled independently of the other sub-pixels. (In a monochrome or gray scale display having only one color of phosphor material, each pixel is considered to have only one sub-pixel; each pixel is identical to its sub-pixel.)

The operating principle of the display is that one or more electron sources 22 mounted on the substrate 10 emit electrons. An anode power supply (not shown) applies to at least one of the one or more anode electrodes 16 a voltage, typically 100 to 20,000 volts, that is positive relative to the electron sources 22, thereby accelerating the emitted electrons toward the phosphors 18 on the face plate 12. The phosphors emit light in response to bombardment by the electrons.

Conventionally, adjacent phosphor sub-pixels are separated by a thin phosphor-free area 24. This separation between sub-pixels is just wide enough so that electrons intended to bombard one color of phosphor do not bombard the adjacent phosphors to any significant extent.

Brighter displays generally require a higher anode voltage, which in turn requires longer spacer posts 14 to provide greater spacing between the face plate 12 and back plate 10 to prevent arcing or other breakdown. For example, for anode voltages in the range of 1000 to 6000 volts, the face plate and back plate should be spaced apart about 0.4 mm to 1 mm, hence each spacer post should have an axial length of this amount. Longer spacer posts also must be greater in diameter or transverse area to achieve a given mechanical strength.

The illustrated display is a field emission display, which means that field emitter tips 22 are used as the type of electron source. Our invention also can be used with displays having other conventional types of electron sources, such as carbon-based emitters or thermionic cathodes. Examples of such displays are described in U.S. Pat. No. 4,031,427 issued Jun. 21, 1977 to Stanley and commonly assigned U.S. Pat. No. 5,859,508 issued Jan. 12, 1999 to Ge et al., the entire contents of each of which are hereby incorporated by reference into this patent specification.

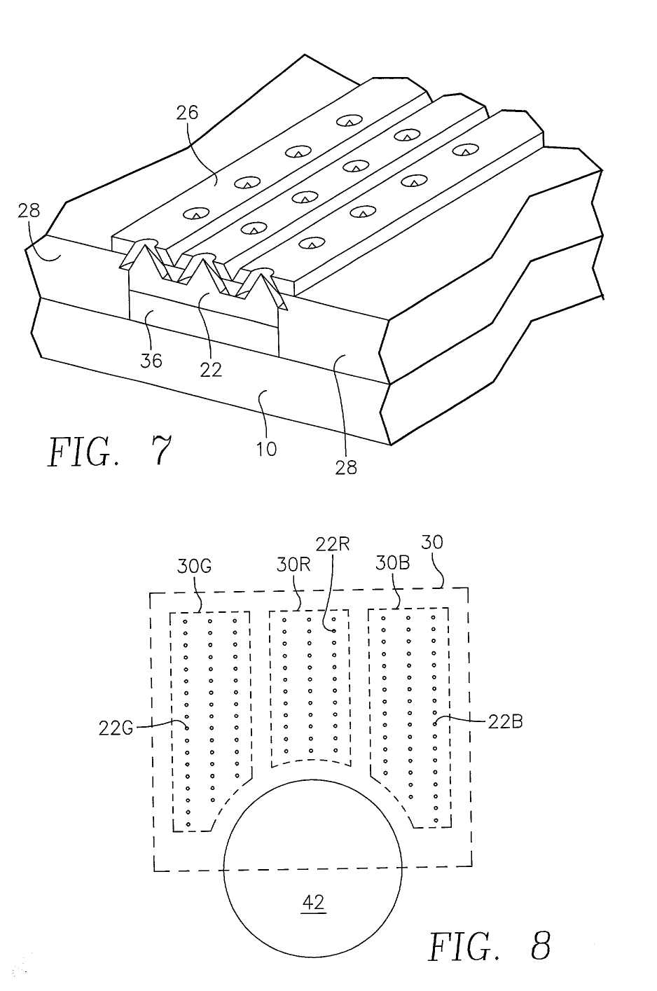

In the illustrated field emission display, each electron source comprises an array of one or more field emitter tips 22 that are electrically connected together (FIGS. 6-8). Coplanar with, or slightly in front of, the tips of the field emitter tips is an array of extraction grid electrodes or gate electrodes 26. Each field emitter tip is adjacent an opening in one of the gate electrodes. In the preferred embodiment, each field emitter tip is approximately conical, and the opening in the grid electrode surrounding each field emitter tip is circular (FIGS. 6 and 7). The gate electrodes are insulated from the substrate and the field emitter tips by a layer of dielectric 28.

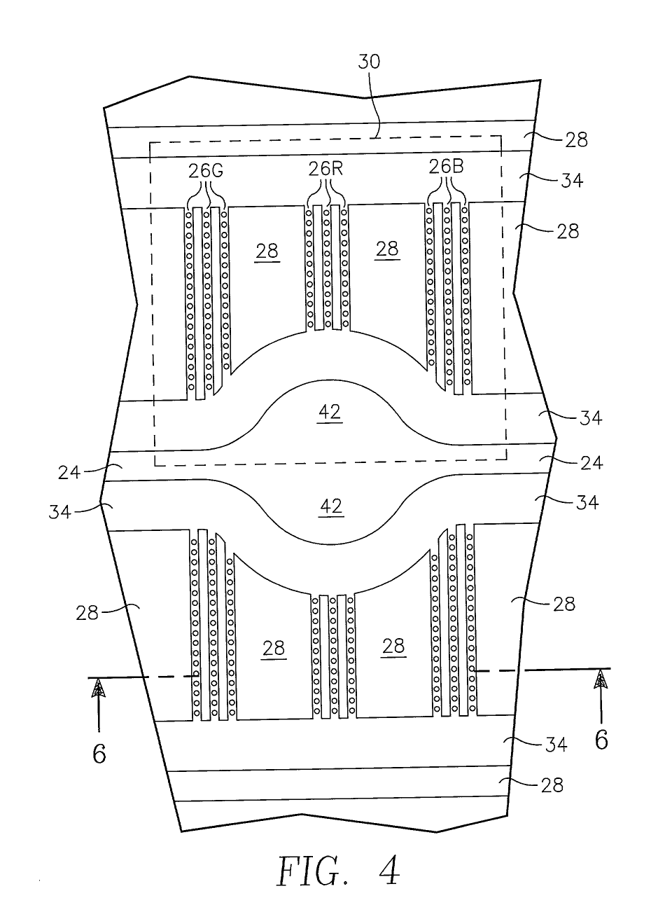

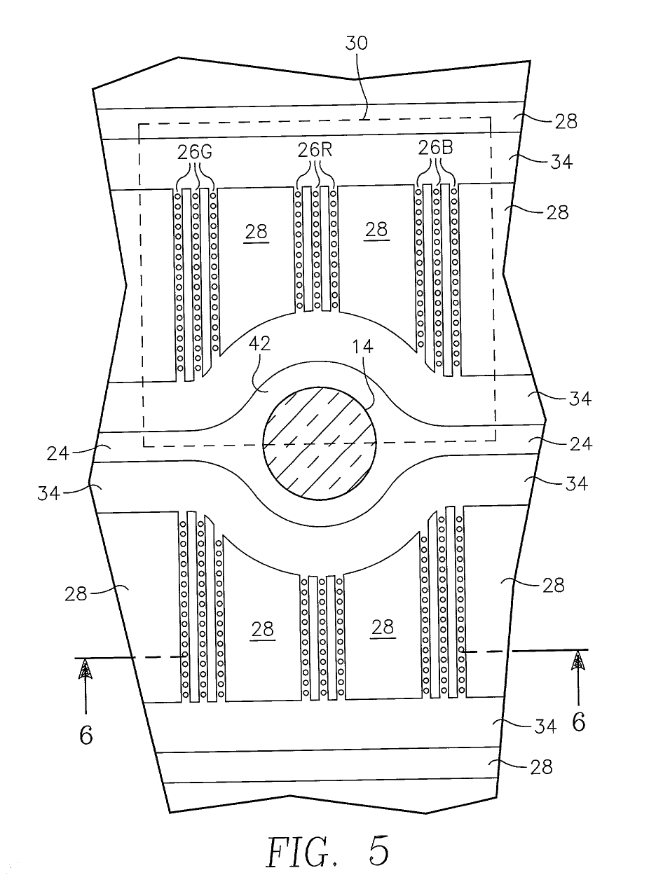

(FIGS. 4 and 5 show the numerous small circular openings in the grid or gate electrodes 26. The field emitter tips 22 are too small to portray in FIGS. 4 and 5, but each circular opening in the gate electrode 26 encircles one field emitter tip 22, as shown in FIG. 7.)

Field emission of electrons from a field emitter tip occurs when the adjacent gate electrode has a voltage that is sufficiently positive relative to the voltage on that field emitter tip. Because the anode power supply generally applies a much higher voltage to the anode electrode than appears on the gate electrode, almost all of the electrons emitted from the field emitter tip will travel through the adjacent opening in the gate electrode and be accelerated toward the anode electrode 16 on the face plate.

In the illustrated preferred embodiment, there is a separate electron source (i.e., a separate array of field emitter tips 22) for each phosphor sub-pixel. Specifically, corresponding to each sub-pixel of red phosphors 18R, there is a sub-pixel group of 117 field emitter tips 22R arranged in three linear segments or stripes of 39 emitter tips each (FIG. 8). Similarly, for each sub-pixel of green phosphors 18G, there is a sub-pixel group of 151 field emitter tips 22G arranged in three stripes of 46, 51 and 54 emitter tips, respectively. The latter also is true of each sub-pixel of blue phosphors 20B and their corresponding emitter tips 22B. There are fewer emitter tips for the red sub-pixels because the red phosphors have a higher conversion efficiency, i.e., they emit more light for a given amount of electron current.

Just as sub-pixels of phosphors of different colors are grouped into pixels of phosphors, the field emitter tips corresponding to the sub-pixels within one phosphor pixel are considered to constitute one pixel of field emitter tips. Specifically, in the preferred embodiment each pixel 30 of field emitter tips includes three sub-pixels of emitter tips 22G, 22R, 22B respectively corresponding to the green, red and blue sub-pixels 18G, 18R, 18B within a corresponding phosphor pixel (FIG. 8).

The illustrated display includes an array of row conductor lines 34 and column conductor lines 36 which can be connected to a conventional scanning type (e.g., progressive scan or interlaced scan) video driver circuit, not shown.

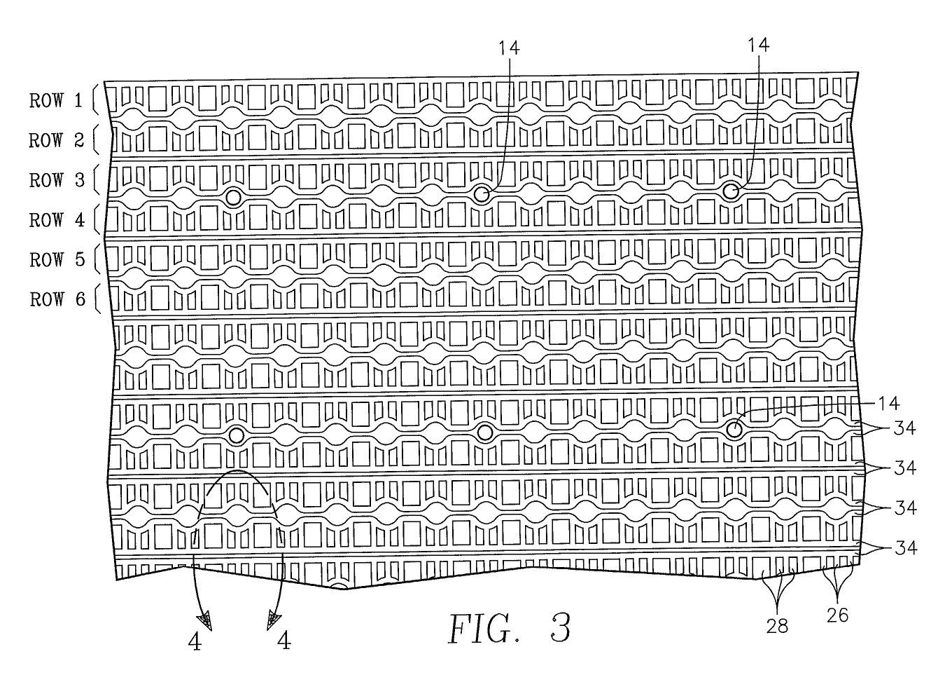

The number of row conductor lines 34 in the display equals M, the number of rows of pixels in the display (FIG. 3). The conventional video driver circuit (not shown) applies an active voltage value to only one row conductor line at a time, stepping through each row line in succession. It applies an inactive voltage value to all row lines other than the one row line that currently is active. The time period during which the video driver applies an active voltage value to the i-th row line is said to be the i-th row scanning period, where i represents any integer from 1 to M.

In our preferred embodiment, each respective row conductor line 34 electrically connects to the gate electrodes associated with the field emitter tips of all the pixels in that respective row of the display. The active and inactive voltages supplied to the row lines by the video driver circuit are +80 volts and +40 volts, respectively, relative to electrical ground. The +80 volt active voltage level is high enough to induce field emission from any corresponding field emitter tips that are electrically grounded.

The display has a separate column conductor line 36 (FIGS. 6 and 7) for each electron source within a row. In the illustrated preferred embodiment, there is a separate electron source for each sub-pixel, so the number of column conductor lines 36 equals 3N, i.e., the number of columns of pixels in the display (N) multiplied by the number of sub-pixels per pixel (3). Each respective column conductor line is associated with one of the three phosphor colors, and it electrically connects to the field emitter tips of all the sub-pixels of that color in that respective column of the display.

During the i-th row scanning period, the video driver circuit applies an active voltage value to the column conductor lines connected to the sub-pixels in the i-th row that are to be illuminated, and applies an inactive voltage value to the column lines connected to the sub-pixels in the i-th row that are to be dark. The video driver circuit can control the brightness of each sub-pixel either by controlling the amplitude of the active voltage signal or, more preferably, controlling the duration (i.e., duty cycle) of the active voltage signal by pulse width modulation.

In our preferred embodiment, the active and inactive voltages supplied to the column lines by the video driver circuit are zero volts and +40 volts, respectively, relative to electrical ground. The field emitter tips of the green sub-pixel at the intersection of the i-row and the k-th column emit electrons when the video driver applies +40 volts to the i-th row conductor line and zero volts to the column conductor line corresponding to the green color in the j-th column.

Other conventional display designs have one electron source per pixel rather than one per sub-pixel. In such designs (not shown), the number of column conductor lines equals N, the number of columns of pixels in the display. To control which color is illuminated, the anode electrodes are divided into three groups corresponding to the three colors of phosphors, and the anode power supply applies the positive anode voltage to only one of the three groups at a time. During each row scanning period, the anode power supply activates the three groups of anode electrodes in succession.

Other display designs employ electrostatic or electromagnetic scanning to reduce the number of electron sources. In such displays, a single electron source or electron gun emits a beam of electrons that is electrostatically or electromagnetically scanned across an entire column of the display, or even across the entire 2-dimensional area of the display. Examples of electrostatically scanned electron sources are described in U.S. Pat. No. 4,028,582 issued Jun. 7, 1977 to Anderson et al., U.S. Pat. No. 4,031,427 issued Jun. 21, 1977 to Stanley, U.S. Pat. No. 4,220,892 issued Sep. 2, 1980 to van Raalte, and U.S. Pat. No. 5,036,317 issued Jul. 30, 1991 to Buzak, the entire contents of each of which is hereby incorporated by reference into this patent specification.

Arrangement of Spacer Posts among Phosphor Pixels

The spacing between the face plate 12 and the substrate 10 is maintained by a large number of dielectric spacer posts 14, wherein each spacer post has first and second ends respectively attached to the face plate and the substrate (FIGS. 1 and 3). The spacer posts should be great enough in number and strength to prevent the face plate and substrate from distorting due to the pressure differential between the vacuum in the cavity between the plates and the atmospheric pressure outside the plates. However, the number of spacer posts preferably should be no greater than necessary to prevent such distortion, because the spacer posts increase the manufacturing cost of the display.

In our invention, the number of spacer posts 14 is no more than half the number of pixels in the display. Preferably the number of spacer posts is much less than this in order to reduce the manufacturing cost of the display. In a display having high pixel density, such as a center-to-center lateral spacing or pitch between pixels of 0.2 mm or less, the required number of spacer posts generally is much smaller than the number of pixels. We believe one spacer post for every 25 to 100 pixels should suffice. For example, the preferred embodiment has one spacer post every four to ten rows of pixels and every four to ten columns of pixels (FIGS. 1-3).

The material strength and the transverse area of the spacer posts also should be sufficient to withstand this pressure differential. In our preferred embodiment, the back plate and face plate are both glass, hence our preferred material for the spacer posts also is glass so that all of these components will have the same coefficient of thermal expansion. Alternatively, the spacer posts can be composed of a ceramic material chosen to have a thermal expansion coefficient close to that of glass or whatever material is used for the back plate and face plate.

The present invention contemplates an arrangement of spacer posts 14 that can be used in any of the display designs described in the preceding sections of this patent specification, or more generally, in any display having at least one electron source mounted on a back plate 10 and an array of phosphors 18 mounted on a face plate 12.

In our invention, the positioning of spacer posts 14 at intervals among the pixels does not disrupt the pixel-to-pixel uniformity of the display because every pixel area of the face plate is designed as if it were intended to be attached to a spacer post. Specifically, each pixel area 20 of the face plate 12 includes a phosphor-free area 40 having an area greater than or equal to the transverse area of the abutting end (the “first end”) of a spacer post divided by a design parameter N, which can be any integer. The pixel areas on the face plate are arranged in distinct groups, where each group contains N adjacent pixel areas. Within each group of N pixel areas, the respective phosphor-free areas of the N pixel areas are contiguous so as to form a combined phosphor-free area equal to or greater than the transverse cross-section of one end of a spacer. Consequently, a spacer can be attached to the face plate at each combined phosphor-free area without disrupting the uniformity of the distribution of phosphors on the face plate.

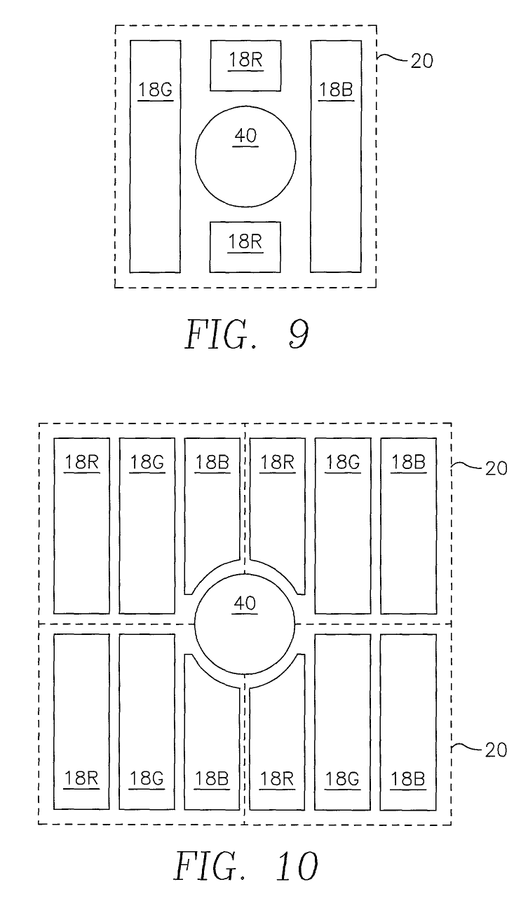

In one possible implementation in which N=1 (FIG. 9), every pixel area 20 of the face plate includes a phosphor-free area 40 (i.e., an area not occupied by phosphor material) that is at least as large as the transverse area of the first end of a spacer post.

In a second possible implementation in which N=2 (FIG. 2), which is the presently preferred embodiment, the phosphor-free area 40 in every pixel is contiguous with a phosphor free area 40 of an adjoining pixel, so that the two phosphor-free areas form a “combined phosphor-free area” at least as large as the transverse area of the abutting end of a spacer post. Consequently, the phosphor-free area of each pixel only needs to be at least one-half the transverse area of a spacer post. For example, FIG. 2 shows the first five rows and the first three columns of the phosphors 18 on the face plate 12. The dashed lines in FIG. 2 represent the boundaries of the pixels 20. In the illustrated embodiment, each pixel in row 1 has a semicircular phosphor-free area 40 that adjoins a semicircular phosphor-free area of the pixel in row 2 of the same column, so that the two phosphor-free areas in combination form a circular phosphor-free area 40 having an area greater than that of the first end of a spacer post. A spacer post 14 is shown occupying the phosphor-free area located at rows 3 and 4 of column 1. All other phosphor-free areas 40 are shown without any spacer post.

In a third possible implementation in which N=4 (FIG. 10), the combined phosphor-free area can occupy the comers of four adjoining pixels, so that the phosphor-free area of each pixel only need be at least one-fourth the transverse area of a spacer post.

Unlike our design, some conventional designs locate their spacer posts within the thin area 24 that separates adjacent phosphor sub-pixels. However, in high density displays this area 24 is very narrow so that the sub-pixels can be spaced as close together as possible. Therefore, the width of the area 24 between adjacent phosphor sub-pixels is likely to be smaller than the transverse width required for each spacer post to have a mechanical strength sufficient to prevent distortion or collapse of the substrate and face plate. An advantage of our invention is that it permits the spacing between sub-pixels (or pixels) to be less than the transverse width of the first end of a spacer post. For example, in the illustrated preferred embodiment, each silicon dioxide spacer post is a cylinder having a length of 400 microns and a diameter of 80 microns, whereas the spacing between adjacent sub-pixels is only 20 microns.

Our design has at least three additional advantages. First, a spacer post can be attached to any pixel area of the display without covering up any of the phosphor material of the pixel, so that the spacer post will not alter the appearance of the pixel. Second, because every pixel area has a similar phosphor-free area irrespective of whether a spacer post actually is attached to that pixel area, all pixels of the display will appear the same even though some of them have spacer posts attached and others do not. This enables the display to have a uniform brightness and resolution. Third, in comparison with designs having a spacer post for every pixel, the display less expensive to manufacture because the number of spacer posts is no more than half the number of pixels.

FIG. 2 shows how the face plate incorporates phosphor-free areas 40 into a conventional array of “striped” (rectangular) phosphors. To provide space for a phosphor-free area 40 in each pixel area 20 of the face plate, the area of each red phosphor sub-pixel 18R is smaller than the respective areas of the green and blue phosphor sub-pixels 18G, 18B. This does not impair the brightness or color balance of the display because using red, green and blue phosphors to produce white light requires a higher intensity of green light than red light.

Alternatively, the color phosphor whose area is reduced to create the phosphor-free areas could be the phosphor having the highest conversion efficiency, i.e., the highest ratio of light emission to electron current. Yet another alternative would be to reduce the area of each of the phosphor colors equally to create the phosphor-free areas.

(More specifically, for the red, green and blue phosphors commonly used in displays, the ratio of luminance of the three phosphors required to produce a white light is about red:green:blue=3:6:1. The blue phosphor typically has a much lower conversion efficiency than the red and green, so typically it is not desirable to reduce the area of the blue phosphor. While the red phosphor typically has a slightly lower conversion efficiency than the green phosphor, its conversion efficiency is much more than one-half that of the green phosphor. Therefore, the area of the red phosphor can be reduced while still achieving the desired 3:6 ratio of red luminance to green luminance.)

In the illustrated embodiment the spacer posts 14 are cylindrical, so each combined phosphor-free area 40 should be circular. Consequently, the green and blue phosphor sub-pixel areas 20G, 20B have a beveled corner to accommodate the circular phosphor-free area 40. However, the invention is not limited to any specific shape of spacer post. For example, each spacer post can have a transverse cross section that is rectangular or cross-shaped.

Because one color of phosphor (e.g., the red phosphor) typically requires less luminance than the other colors for the desired white color balance, it should be possible in most applications to reduce the area of the sub-pixel of that color by an amount even greater than the transverse area of the spacer post. That is, it should be possible to make each phosphor-free area 40 substantially larger than the area of the abutting end of a spacer post.

An important advantage of each combined phosphor-free area 40 being substantially larger than the area of the abutting end of a spacer post is that it enables each spacer post to be substantially misaligned without extending outside the phosphor-free area. This can increase the production yield when the display is manufactured; that is, it can reduce the percentage of displays that would have to be rejected because some of the spacer posts are misaligned and obstruct some of the phosphors or field emitter tips. Conversely, making the combined phosphor-free area larger enables the use of a less accurate, and hence less expensive, process for attaching the spacer posts to the back plate or face plate.

In the illustrated preferred embodiment, the diameter of each spacer post 14 is about two-thirds the diameter of each combined phosphor-free area 40. Therefore, the transverse area of each spacer post is about one-half the area of each combined phosphor-free area.

Arrangement of Spacer Posts among Electron Source Pixels

The preceding discussion of the invention relates only to the attachment of the first end of each spacer post 14 to the face plate 12. As stated earlier, the second end of each spacer post is attached to the substrate or back plate 10.

If the display has one electron source per pixel, or one electron source per sub-pixel as in the preferred embodiment, then the spacer posts potentially could interfere with the pixel-to-pixel uniformity of the current emitted by the electron sources. Our invention overcomes this problem in a manner analogous to the design of the pixel areas 20 on the face plate as just described.

Specifically, each pixel area 30 of the substrate or back plate 10 includes an area that is not occupied by an electron emission source, and this “source-free” or “emitter-free” area 42 is at least as large as the transverse area of the abutting end (the “second end”) of a spacer post 14 divided by the aforesaid design parameter N, which can be any integer. The pixel areas on the substrate are arranged in distinct groups, where each group contains N adjacent pixel areas. Within each group of N pixel areas, the respective emitter-free areas of the N pixel areas are contiguous so as to form a combined emitter-free area 42 equal to or greater than the transverse cross-section of one end of a spacer. Consequently, a spacer can be attached to the substrate at each combined source-free area without disrupting the pixel-to-pixel uniformity of the current emitted by the electron sources.

In a field emission display (i.e., a display in which each electron source comprises one or more field emitter tips), the “source-free” or “emitter-free” area 42 within each pixel area 30 on the substrate is defined as an area that is not occupied by any field emitter tips 22.

For the three previously discussed values of the design parameter N equal to 1, 2 and 4, respectively, the geometric arrangement of emitter-free areas 42 on the substrate 10 can be the same as the respective arrangements of phosphor-free areas 40 on the face plate 12, as shown in FIGS. 9, 2 and 10, respectively.

FIG. 8 depicts a single pixel area 30 on the substrate or back plate 10 in the preferred embodiment in which N=2. As stated earlier, each red sub-pixel 30R on the substrate has 117 field emitter tips 22R arranged in three linear stripes or segments of 39 emitter tips each. Similarly, each green or blue sub-pixel 30G, 30B has 151 field emitter tips 22G, 22B arranged in three stripes of 46, 51 and 54 emitter tips, respectively. The shorter stripes of emitter tips correspond to the beveled corner of the corresponding phosphor stripe 18G, 18B on the face plate.

The field emitter sub-pixels 30R, 30G, 30B shown in FIG. 8 are approximately the same size, shape, and geometric arrangement as the corresponding phosphor sub-pixels 20R, 20G, 20B shown in FIG. 2. To provide space for an emitter-free area 42 in each pixel area 30 of the substrate, each red field emitter sub-pixel 30R on the substrate is smaller in area than the green and blue field emitter sub-pixels 30G, 30B, just as each red phosphor sub-pixel 20R is smaller than the green and blue phosphor sub-pixels 20G, 20B.

FIGS. 1 and 3-5 show how each row conductor line 34 connects to the gate electrodes 26 within a row. In particular, the figures show how the row conductor line encircles the emitter-free area 42, so that a spacer post can be attached to the emitter-free area without interrupting the continuity of the column conductor line. Although not required by the invention, each row actually has two row conductor lines connecting to opposite ends of the gate electrodes.

FIGS. 1 and 3-7 show that a dielectric layer 28 supports the extraction gate electrodes 26 and that this dielectric layer covers all portions of the substrate that are not occupied by the field emitter tips 22, the gate electrodes, or the row conductor lines 34. Accordingly, the exposed surface of each emitter-free area 42 consists of such dielectric 28. Therefore, the means by which the second end of each spacer post 14 is mounted to the substrate actually is to attach the second end of the spacer post directly to the dielectric layer 28. To facilitate bonding the spacer posts to the dielectric layer 28, both can be composed of similar dielectric material, such as silicon dioxide.

Alternatively, if a process is available for bonding the second end of each spacer post to the conductive material of the row conductor lines or the gate electrodes, there is no reason why the row conductor lines or the gate electrodes should be precluded from overlying the emitter-free areas 42.

As described above in relation to the phosphor-free areas on the face plate, it is desirable for the emitter-free areas on the substrate to be larger than the abutting ends of the spacer posts so that misalignment of the spacer posts can be tolerated. In the preferred embodiment, each emitter-free area 42 has a diameter about 50% greater than that of the second end of a spacer post, which means each emitter-free area is about twice the transverse area of the second end of a spacer post.

Our design enables the use of spacer posts whose second ends have a transverse width greater than the separation between field emitter tips of adjacent sub-pixels or pixels, and much greater than the average separation between adjacent field emitter tips. For example, in the illustrated preferred embodiment, the diameter of each spacer post is 80 microns, whereas the spacing between the emitter tips of adjacent sub-pixels is only 20 microns. The field emitter tips within each of the three lines of tips within a sub-pixel are spaced at only 4 microns between centers.

Although the invention has been described in terms of flat panel displays in which each pixel includes a phosphor material to emit light, the pixels can include other types of electro-optic material or devices. For example, instead of phosphors, the electro-optic material can be one or more liquid crystal cells that modulate the transmission or reflection of light in response to electrons emitted by the electron source 22. A flat panel display using such liquid crystal material is described in U.S. Pat. No. 5,036,317 issued Jul. 30, 1991 to Buzak, the entire contents of which is hereby incorporated by reference into this patent specification. Therefore, wherever an aspect of the invention is described above in terms of phosphor area or phosphor pixels, any electro-optic material or device can be substituted for the described phosphor.

1. A flat panel display comprising:
a back plate having a first surface;
at least one electron emitter mounted adjacent the first surface of the back plate;
a face plate having a first surface positioned parallel to and facing the first surface of the back plate, wherein the first surface of the face plate includes a plurality of distinct pixel areas, and wherein the pixel areas are arranged in distinct groups such that each group includes N pixel areas, where N is an integer;
phosphor material mounted on the pixel areas of the face plate, wherein no two portions of phosphor material mounted on the same pixel area of the face plate have respective light emissions that are independently controllable and are of the same color; and
a plurality of spacer posts, wherein each spacer post has first and second opposite ends respectively attached to the face plate and the back plate so as to maintain the face plate and the back plate parallel to each other at a fixed separation, and wherein the first end of each spacer post is characterized by a first transverse cross section having an area;
wherein each pixel area of the face plate includes a phosphor-free area that is not occupied by phosphor material, wherein each phosphor-free area is equal to or greater than the area of said first transverse cross section divided by N;
wherein, for each group, the respective phosphor-free areas of each pixel area of that group are contiguous so as to form a combined phosphor-free area equal to or greater than the area of said first transverse cross section;
wherein the first end of each respective spacer post is attached to the face plate at a respective one of the combined phosphor-free areas; and
wherein the number of said spacer posts in the display is no greater than one-half the number of combined phosphor-free areas in the display, so that no more than one-half of the combined phosphor-free areas are attached to any of the spacer posts.

2. A display according to claim 1, wherein:
said pixel areas of the face plate are substantially identical in area; and
said phosphor-free areas are substantially identical in area.

3. A display according to claim 1, wherein:
the phosphor material on each pixel area of the face plate comprises one or more sub-pixels of phosphor material such that:
the phosphor material of each sub-pixel within any one pixel area emits light having a color different from the color of light emitted by the phosphor material of any other sub-pixel within said one pixel area, and
no portion of the phosphor material within any one of the sub-pixels has a light emission that is controllable independently of a light emission from any other portion of phosphor material within said one sub-pixel; and
the first end of each spacer post has a transverse width substantially greater than the average separation between adjacent sub-pixels of phosphor material.

4. A field emission display comprising:
a face plate having a first surface;
a plurality of pixels of phosphor material mounted on the first surface of the face plate, wherein no two portions of the same pixel of phosphor material have respective light emissions that are independently controllable and are of the same color;
a substrate having a first surface positioned parallel to and facing the first surface of the face plate, wherein the first surface of the substrate includes a plurality of distinct substrate pixel areas, and wherein the substrate pixel areas are arranged in distinct groups such that each group includes N substrate pixel areas, where N is an integer;
a plurality of field emitter tips mounted on the first surface of the substrate, wherein
the field emitter tips are distributed among the substrate pixel areas so that each substrate pixel area includes at least one field emitter tip, and
each substrate pixel area is associated with a distinct, corresponding one of the pixels of phosphor material so that electrons emitted by the at least one field emitter tip of any one substrate pixel area are directed toward the pixel of phosphor material corresponding to said one substrate pixel area; and
a plurality of spacer posts, wherein each spacer post has first and second opposite ends respectively attached to the face plate and the substrate so as to maintain the face plate and the substrate parallel to each other at a fixed separation, and wherein the second end of each spacer post is characterized by a transverse cross section having an area;
wherein each substrate pixel area includes an emitter-free area that is not occupied by field emitter tips, wherein each emitter-free area is equal to or greater than the area of said transverse cross section divided by N;
wherein, for each group, the respective emitter-free areas of each substrate pixel area of that group are contiguous so as to form a combined emitter-free area equal to or greater than the area of said transverse cross section;
wherein the second end of each respective spacer post is attached to the substrate at a respective one of the combined emitter-free areas; and
wherein the number of said spacer posts in the display is no greater than one-half the number of combined emitter-free areas in the display, so that no more than one-half of the combined emitter-free areas are attached to any of the spacer posts.

5. A display according to claim 4, wherein:
said substrate pixel areas are substantially identical in area; and
said emitter-free areas are substantially identical in area.

6. A display according to claim 4, wherein the second end of each spacer post has a transverse width substantially greater than the average separation between adjacent field emitter tips.

7. A display according to claim 4, wherein the second end of each spacer post has a transverse width substantially greater than the separation between the field emitter tips of adjacent pixels.

8. A method of fabricating a flat panel display, comprising the steps of:
providing a plurality of spacer posts, wherein each spacer post has first and second opposite ends, and wherein the first end of each spacer post is characterized by a first transverse cross section having an area,
providing a back plate having a first surface;
mounting at least one electron emitter on the first surface of the back plate;
providing a face plate having a first surface that includes a plurality of distinct pixel areas, wherein the pixel areas are arranged in distinct groups such that each group includes N pixel areas, where N is an integer,
wherein each pixel area of the face plate includes a phosphor-free area that is not occupied by phosphor material, wherein each phosphor-free area is equal to or greater than the area of said first transverse cross section divided by N, and
wherein, for each group, the respective phosphor-free areas of each pixel area of that group are contiguous so as to form a combined phosphor-free area equal to or greater than the area of said first transverse cross section;
mounting the face plate so that the first surface of the face plate is parallel to and faces the first surface of the back plate;
mounting phosphor material on the pixel areas of the face plate, wherein no two portions of phosphor material mounted on the same pixel area of the face plate have respective light emissions that are independently controllable and are of the same color;
attaching the first and second ends of each spacer post to the face plate and the back plate, respectively, so as to maintain the face plate and the back plate parallel to each other at a fixed separation, wherein the first end of each respective spacer post is attached to the face plate at a respective one of the combined phosphor-free areas;
wherein the number of said spacer posts in the display is no greater than one-half the number of said combined phosphor-free areas in the display, so that no more than one-half of the combined phosphor-free areas are attached to any of the spacer posts.

9. A method according to claim 8, wherein:
said pixel areas of the face plate are substantially identical in area; and
said phosphor-free areas are substantially identical in area.

10. A method according to claim 8, wherein:
the phosphor material on each pixel area of the face plate comprises one or more sub-pixels of phosphor material such that:
the phosphor material of each sub-pixel within any one pixel area emits light having a color different from the color of light emitted by the phosphor material of any other sub-pixel within said one pixel area, and
no portion of the phosphor material within any one of the sub-pixels has a light emission that is controllable independently of a light emission from any other portion of phosphor material within said one sub-pixel; and
the first end of each spacer post has a transverse width substantially greater than the average separation between adjacent sub-pixels of phosphor material.

11. A method of fabricating a field emission display, comprising the steps of:
providing a plurality of spacer posts, wherein each spacer post has first and second opposite ends, and wherein the second end of each spacer post is characterized by a transverse cross section having an area,
providing a face plate having a first surface;
mounting a plurality of pixels of phosphor material on the first surface of the face plate, wherein no two portions of the same pixel of phosphor material have respective light emissions that are independently controllable and are of the same color;
providing a substrate having a first surface that includes a plurality of distinct substrate pixel areas, wherein the substrate pixel areas are arranged in distinct groups such that each group includes N substrate pixel areas, where N is an integer,
wherein each substrate pixel area includes an emitter-free area that is not occupied by field emitter tips, wherein each emitter-free area is equal to or greater than the area of said transverse cross section divided by N, and
wherein, for each group, the respective emitter-free areas of each substrate pixel area of that group are contiguous so as to form a combined emitter-free area equal to or greater than the area of said transverse cross section;
positioning the first surface of the substrate parallel to and facing the first surface of the face plate;
mounting a plurality of field emitter tips on the first surface of the substrate,
wherein the field emitter tips are distributed among the substrate pixel areas so that each substrate pixel area includes at least one field emitter tip, and
wherein each substrate pixel area is associated with a distinct, corresponding one of the pixels of phosphor material so that electrons emitted by the at least one field emitter tip of any one substrate pixel area are directed toward the pixel of phosphor material corresponding to said one substrate pixel area; and
attaching the first and second ends of each spacer post to the face plate and the substrate, respectively, so as to maintain the face plate and the substrate parallel to each other at a fixed separation, wherein the second end of each respective spacer post is attached to the substrate at a respective one of the combined emitter-free areas;
wherein the number of said spacer posts in the display is no greater than one-half the number of combined emitter-free areas in the display, so that no more than one-half of the combined emitter free areas are attached to any of the spacer posts.

12. A method according to claim 11, wherein:
said substrate pixel areas are substantially identical in area; and
said emitter-free areas are substantially identical in area.

13. A method according to claim 11, wherein the second end of each spacer post has a transverse width substantially greater than the average separation between adjacent field emitter tips.

14. A method according to claim 11, wherein the second end of each spacer post has a transverse width substantially greater than the separation between the field emitter tips of adjacent pixels.
